(19) United States
(12) Patent Application Publication
(10) Pub. No.: US 2012/0093526 A1
(43) Pub. Date: Apr. 19, 2012

(54) IMAGE FORMING APPARATUS AND GUIDANCE DISPLAY METHOD IN THE IMAGE FORMING APPARATUS

(75) Inventor: Kazumasa Yasui, Tokyo-to (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/273,614

(22) Filed: Oct. 14, 2011

Related U.S. Application Data
(60) Provisional application No. 61/394,565, filed on Oct. 19, 2010.
(60) Provisional application No. 61/394,568, filed on Oct. 19, 2010.

(51) Int. Cl. G03G 15/00; G03G 13/00

(52) U.S. Cl. 399/21

(57) ABSTRACT

According to one embodiment, an image forming apparatus includes a paper feeding section, a conveying section, an image forming section, and a display section. The paper feeding section feeds a set sheet. The conveying section conveys the sheet fed from the paper feeding section. The image forming section forms an image on the sheet conveyed by the conveying section. The display section displays sheet set guidance corresponding to a type of the sheet set in the paper feeding section.

### CROSS-REFERENCE TO RELATED APPLICATIONS

This application is based upon and claims the benefit of priority from U.S. Provisional Application No. 61/394,565 filed on Oct. 19, 2010; and U.S. Provisional Application No. 61/394,568 filed on Oct. 19, 2010; the entire contents of which are incorporated herein by reference.

### FIELD

Embodiments described herein relate generally to an image forming apparatus and a guidance display method in the image forming apparatus.

### BACKGROUND

User-friendly operation guidance is necessary for an image forming apparatus such as a digital multi-functional peripheral. In one case, a jam that occurs in feeding of sheets is caused by incorrect setting of the sheets in a cassette. However, a method of correctly setting the sheets in the cassette is different depending on a type of the sheets. Therefore, it is difficult for a user to understand the method. In another case, a jam that occurs in feeding of sheets is caused by wear of rollers used for the paper feeding. However, it is difficult for the user to determine that the cause of the jam is the wear of the rollers.

### BRIEF DESCRIPTION OF THE DRAWINGS

FIG. 1 is an external view of a configuration example of a digital multi-functional peripheral;

FIG. 2 is a sectional view of the configuration example of the digital multi-functional peripheral;

FIG. 3A is a diagram of a first arrangement example of three sheet sensors that function as a skew detection sensor;

FIG. 3B is a diagram of a second arrangement example of the three sheet sensors that function as the skew detection sensor;

FIG. 3C is a diagram of a third arrangement example of the three sheet sensors that function as the skew detection sensor;

FIG. 3D is a diagram of a fourth arrangement example of the three sheet sensors that function as the skew detection sensor;

FIG. 4 is a diagram of a configuration example of a control panel;

FIG. 5 is a block diagram for explaining a configuration example of a control system in a digital multi-functional peripheral;

FIG. 6 is a flowchart for explaining display processing for displaying sheet set guidance if sheets are set;

FIG. 7 is a diagram of a display example of plain paper set guidance for setting plain paper in a cassette;

FIG. 8 is a diagram of a display example of postcard set guidance for setting postcards in the cassette;

FIG. 9 is a diagram of a display example of coat paper set guidance for setting coat paper in the cassette;

FIG. 10 is a diagram of a display example of plain paper set guidance for setting plain paper in a bypass feeder;

FIG. 11 is a diagram of a display example of long paper set guidance for setting long paper in the bypass feeder;

FIG. 12 is a diagram of a display example of postcard set guidance for setting postcards in the bypass feeder;

FIG. 13 is a diagram of a display example of coat paper set guidance for setting coat paper in the bypass feeder;

FIG. 14 is a flowchart for explaining a processing example performed if a jam occurs during printing;

FIG. 15 is a diagram of an example of first jam release guidance for a paper feed jam;

FIG. 16 is a diagram of an example of second jam release guidance for the paper feed jam;

FIG. 17 is a diagram of a display example of sheet set guidance transitioning from jam release guidance;

FIG. 18 is a diagram of an example of first jam release guidance for a skew-related jam;

FIG. 19 is a diagram of an example of second jam release guidance for the skew-related jam;

FIG. 20 is a diagram of an example of third jam release guidance for the skew-related jam;

FIG. 21 is a diagram of an example of fourth jam release guidance for the skew-related jam;

FIG. 22 is a diagram of an example of fifth jam release guidance for the skew-related jam;

FIG. 23 is a diagram of a display example of cassette change guidance displayed if the life of rollers runs out;

FIG. 24 is a diagram of a display example of guidance for a change to the bypass feeder displayed if the life of the rollers runs out;

FIG. 25 is a diagram of a display example of cassette change guidance displayed if a paper feed jam frequently occurs;

FIG. 26 is a diagram of a display example of guidance for a change to the bypass feeder displayed if the paper feed jam frequently occurs; and

FIG. 27 is a flowchart for explaining a processing example for checking roller life and frequent occurrence of jams before starting printing.

### DETAILED DESCRIPTION

In general, according to one embodiment, an image forming apparatus includes a paper feeding section, a conveying section, an image forming section, and a display section. The paper feeding section feeds a set sheet. The conveying section conveys the sheet fed from the paper feeding section. The image forming section forms an image on the sheet conveyed by the conveying section. The display section displays sheet set guidance corresponding to a type of the sheet set in the paper feeding section.

An embodiment is explained below with reference to the drawings.

First, the configuration of a digital multi-functional peripheral (MFP) as an image forming apparatus is explained.

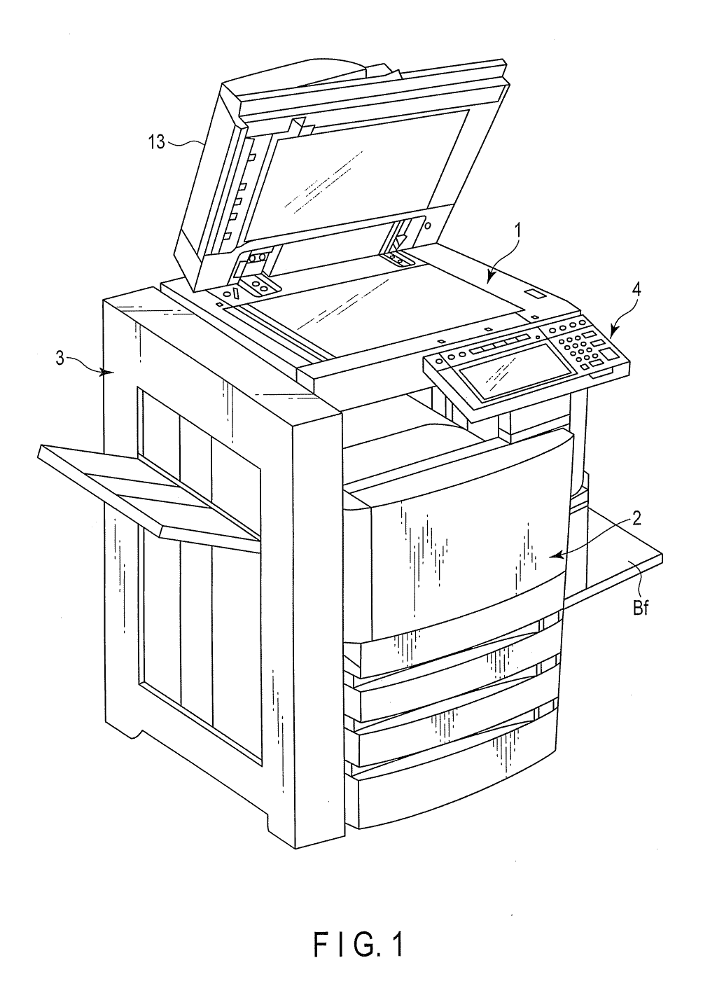

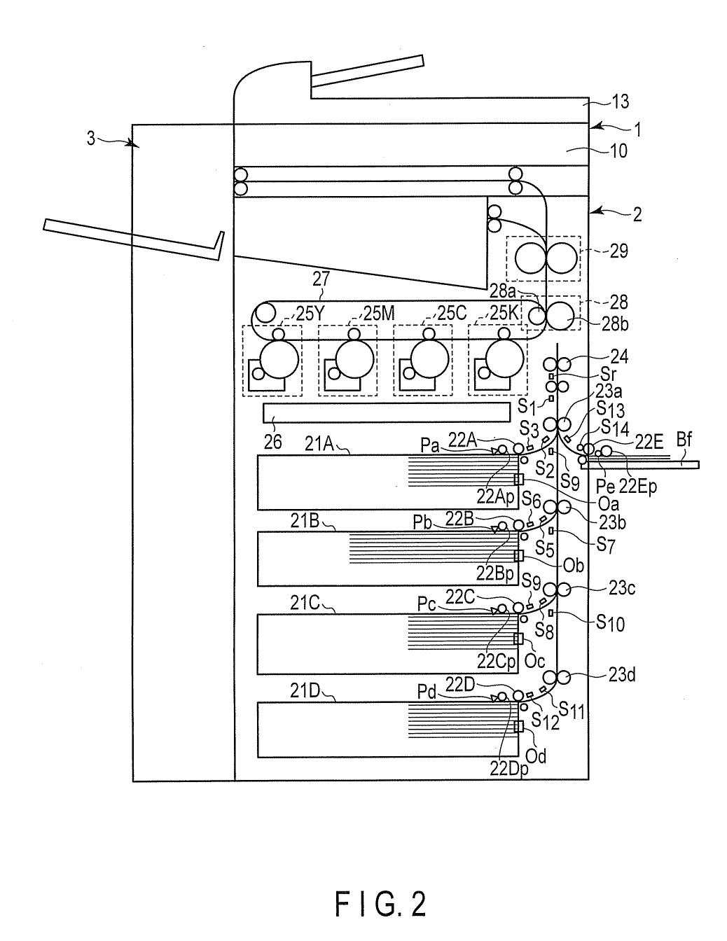

FIG. 1 is a perspective view of an external configuration example of the digital multi-functional peripheral. FIG. 2 is a schematic sectional view of an internal configuration example of the digital multi-functional peripheral.

As shown in FIG. 1, the digital multi-functional peripheral includes a scanner 1, a printer 2, a finisher 3, and a control panel 4.

The scanner 1 is set in an upper part of a main body of the digital multi-functional peripheral. The scanner 1 is an apparatus configured to optically read an image of an original document. The scanner 1, a sectional view of which is shown in FIG. 2, includes an image reading section 10 functioning as a photoelectric conversion section including a CCD line sensor configured to convert an image for one line in a main scanning direction in an original document into image data. The image reading section 10 reads an image of the entire original document by scanning the CCD line sensor in a sub-scanning direction of the original document. The scanner 1 includes an auto document feeder (ADF) 13. The ADF 13 feeds original documents set in a paper feeding tray one by one. The scanner 1 reads an image of the original document fed by the ADF 13.

The printer 2 includes, as paper feeding stages for sheets, paper feeding cassettes 21A, 21B, 21C, and 21D and a bypass feeder Bf. The paper feeding cassettes 21A, 21B, 21C, and 21D store sheets serving as image formation medium on which images are printed. For example, each of the paper feeding cassettes 21A, 21B, 21C, and 21D are detachably attachable in a lower part of the main body of the digital multi-functional peripheral. The paper feeding cassettes 21A, 21B, 21C, and 21D respectively include opening and closing sensors Oa, Ob, Oc, and Od that detect opening and closing states of the cassettes. If the cassettes 21A, 21B, 21C, and 21D are opened, the opening and closing sensors Oa, Ob, Oc, and Od output signals indicating that the cassettes 21A, 21B, 21C, and 21D are opened. If the cassettes 21A, 21B, 21C, and 21D are closed, the opening and closing sensors Oa, Ob, Oc, and Od output signals indicating that the cassettes 21A, 21B, 21C, and 21D are closed.

Sheet sensors Pa, Pb, Pc, and Pd are respectively provided in the paper feeding cassettes 21A, 21B, 21C, and 21D. The sheet sensors Pa, Pb, Pc, and Pd respectively output signals indicating presence or absence of sheets in the paper feeding cassettes 21A, 21B, 21C, and 21D. A sheet sensor Pe is provided in the bypass feeder Bf. The sheet sensor Pe outputs a signal indicating presence or absence of sheets in the bypass feeder Bf. According to the detection signal output by the sheet sensor Pe, it is possible to detect that the sheet is detected in the bypass feeder Bf.

The paper feeding cassettes 21A, 21B, 21C, and 21D respectively include paper feeding rollers 22A, 22B, 22C, and 22D. Each of the paper feeding rollers 22A, 22B, 22C, and 22D pick up the sheets from the paper feeding cassettes 21A, 21B, 21C, and 21D one by one. Pickup rollers 22Ap, 22Bp, 22Cp, and 22Dp are respectively provided in the paper feeding cassettes 21A, 21B, 21C, and 21D as rollers of paper feeding systems in addition to the paper feeding rollers 22A, 22B, 22C, and 22D. The bypass feeder Bf includes a paper feeding roller 22E respectively. The paper feeding roller 22E picks up sheets set in the bypass feeder Bf one by one. A pickup roller 22Ep is provided on the bypass feeder Bf as a roller of a paper feeding system in addition to the paper feeding roller 22E. The pickup roller 22Ep delivers the sheets set in the bypass feeder Bf to the paper feeding roller 22E.

A conveying section 23 conveys sheets in the printer 2. The conveying section 23 includes plural conveying rollers provided between each of the paper feeding rollers 22A, 22B, 22C, and 22D and a discharge port for sheets. For example, plural conveying rollers 23a to 23d are provided in a conveying path from each of the paper feeding rollers 22A, 22B, 22C, 22D, and 22E to a registration roller 24. The conveying rollers 23a to 23d convey sheets, which are fed by each of the paper feeding rollers 22A, 22B, 22C, 22D, and 22E, to the registration roller 24. The registration roller 24 conveys the sheets to a transfer position at timing when images are transferred onto the sheets.

Sheet sensors S1 to S14 and Sr are set in the conveying path from each of the paper feeding rollers 22A, 22B, 22C, 22D, and 22E to the registration roller 24. The sheet sensor Sr is provided before the registration roller 24. The sheet sensors S1 to S14 and Sr output signals for detecting presence or absence of sheets in places on the conveying path. Conveyance of the sheets in the printer 2 is controlled on the basis of detection states of the sheets by the sheet sensors on the conveying path including the sheet sensors S1 to S14 and Sr. For example, a jam of a sheet in the printer 2 is determined on the basis of detection results by each of the sheet sensors.

Specific three sheet sensors among the sheet sensors S1 to S14 are combined and function as a skew detection sensor. For example, the sheet sensors S1, S2, and S3 detect conveyance of a sheet from the paper feeding cassette 21A to the registration roller 24 and function as a skew detection sensor configured to detect a skew of a sheet fed from the paper feeding cassette 21A.

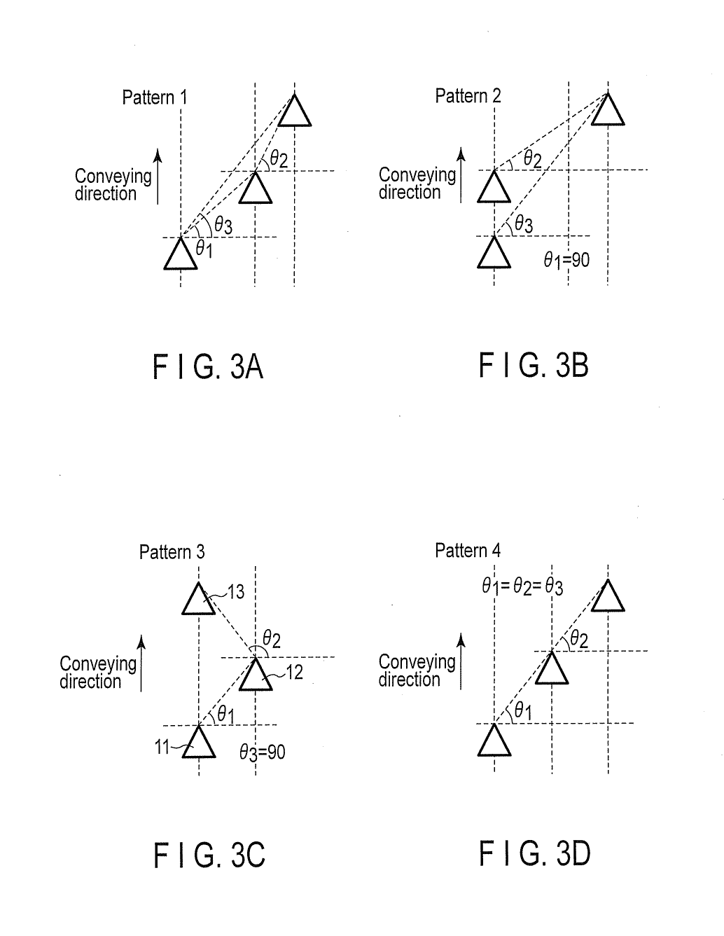

FIGS. 3A, 3B, 3C, and 3D are diagrams of arrangement examples of the three sheet sensors functioning as the skew detection sensor. For example, the sheet sensors S1, S2, and S3 also functioning as the skew detection sensor are set such that positional relations in a conveying direction are arrangements shown in FIGS. 3A, 3B, 3C, and 3D. Specifically, a skew with respect to the conveying direction of a sheet fed from the paper feeding cassette 21A can be detected according to timing when the three sheet sensors S1, S2, and S3 arranged as shown in FIGS. 3A, 3B, 3C, and 3D detect the sheet.

The sheet sensors S4, S5, and S6 are set to have a predetermined positional relation shown in FIG. 3A, 3B, 3C, or 3D and function as a skew detection sensor configured to detect a skew of a sheet fed from the paper feeding cassette 21B. The sheet sensors S7, S8, and S9 are set to have the predetermined positional relation shown in FIG. 3A, 3B, 3C, or 3D and function as a skew detection sensor configured to detect a skew of a sheet fed from the paper feeding cassette 21C. The sheet sensors S10, S11, and S12 are set to have the predetermined positional relation shown in FIG. 3A, 3B, 3C, or 3D and function as a skew detection sensor configured to detect a skew of a sheet fed from the paper feeding cassette 21D. The sheet sensors S1, S13, and S14 are set to have the predetermined positional relation shown in FIG. 3A, 3B, 3C, or 3D and function as a skew detection sensor configured to detect a skew of a sheet fed from the bypass feeder Bf.

Plural image forming sections 25 (25Y, 25M, 25C, and 25K) respectively form images of each of colors (yellow, magenta, cyan, and black). An exposing section 26 forms electrostatic latent images, which are images to be developed in each of the colors, on image bearing members in each of the image forming sections 25 (25Y, 25M, 25C, and 25K). An intermediate transfer belt 27 is an intermediate transfer member. Each of the image forming sections 25 (25Y, 25M, 25C, and 25K) develop the electrostatic latent images with toners of each of the colors (yellow, magenta, cyan, and black) to thereby form toner images on the intermediate transfer belt 27.

Each of the image forming sections 25Y, 25M, 25C, and 25K transfer (primarily transfer) the toner images developed with the toners of each of the colors (yellow, magenta, cyan, and black) onto the intermediate transfer belt 27 to be superimposed one on top of another. The intermediate transfer belt 27 holds a color image in which the toner images of each of the colors overlap one another. A transfer section 28 transfers the color image formed by the toners of the plural colors onto a sheet in a secondary transfer position. The secondary transfer position is a position where the toner images on the intermediate transfer belt 27 are transferred onto the sheet. In the secondary transfer position, a secondary transfer roller 28b is present in a position where a supporting roller 28a and the intermediate transfer belt 27 are opposed to each other. The registration roller 24 conveys a sheet to the secondary transfer position to be timed to coincide with the toner images on the intermediate transfer belt 27.

The transfer section 28 supplies the sheet, onto which the toner images are transferred, to a fuser 29. The fuser 29 fixes the toner images on the sheet. The fuser 29 heats the sheet, onto which the toner images are transferred by the transfer section 28, in a pressed state. The fuser 29 conveys the sheet subjected to the fixing processing to a paper discharge section 30 or the finisher 3.

The printer 2 shown in FIG. 2 is a printer of an electrophotographic system. A printer according to this embodiment is not limited to the electrophotographic system. This embodiment can be applied to, for example, a printer of an inkjet system or a thermal transfer system other than the electrophotographic system.

The finisher 3 processes sheets having images formed by the printer 2. The finisher 3 includes an exit tray on which the sheets having the images formed thereon by the printer 2 are accumulated. The finisher 3 may includes a function of moving the exit tray every time the printer 2 discharges sheets in one copy unit, a stapling function of stapling the sheets accumulated on the exit tray, or a hole punching function of punching holes in the sheets accumulated on the exit tray.

The control panel 4 is a user interface. The control panel 4 displays guidance and receives the input of an operation button or an icon. For example, a user inputs setting information on the control panel 4.

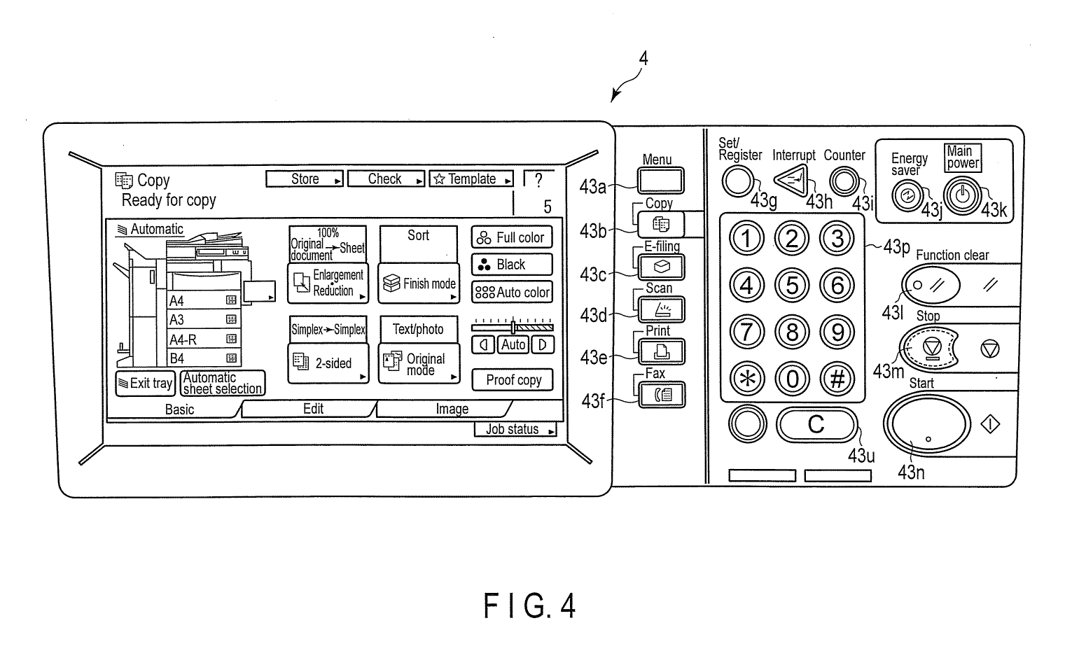

FIG. 4 is a diagram of a configuration example of the control panel 4. In the example shown in FIG. 4, the control panel 4 includes a display device 41, a touch panel 42, and plural operation buttons 43. The display device 41 displays guidance. The display device 41 includes the touch panel 42 on a display screen. The touch panel 42 detects a region touched by the user on the display screen of the display device 41. The user can select, through the touch panel 42, an icon displayed by the display device 41. The plural operation buttons 43 are hard keys such as a reset button, a stop button, a start button, a clear button, and a ten key.

The plural operation buttons 43 include a menu button 43a, operation mode selection buttons (a copy button 43b, a filing box button 43c, a scanner button 43d, a print button 43e, and a facsimile button 43f), a setting registration button 43g, an interrupt button 43h, a counter button 43i, a energy saver button 43j, a main power button 43k, a function clear button 43l, a stop button 43m, a start button 43n, a clear button 43o, and a ten key 43p.

For example, if the user uses a copy mode, the user presses the copy button 43b. If the user presses the copy button 43b, the digital multi-functional peripheral enters the copy mode. If the digital multi-functional peripheral is in the copy mode, the display device 41 displays a copy setting screen. In a state in which the copy setting screen is displayed, the user can change setting content to desired setting content. For example, the user can set a type of a sheet on which an image is printed, a cassette, and the like through the touch panel 42. If the start button 43n is pressed, the digital multi-functional peripheral executes copying according to the setting content displayed on the display device 41.

The configuration of a control system of the digital multi-functional peripheral is explained.

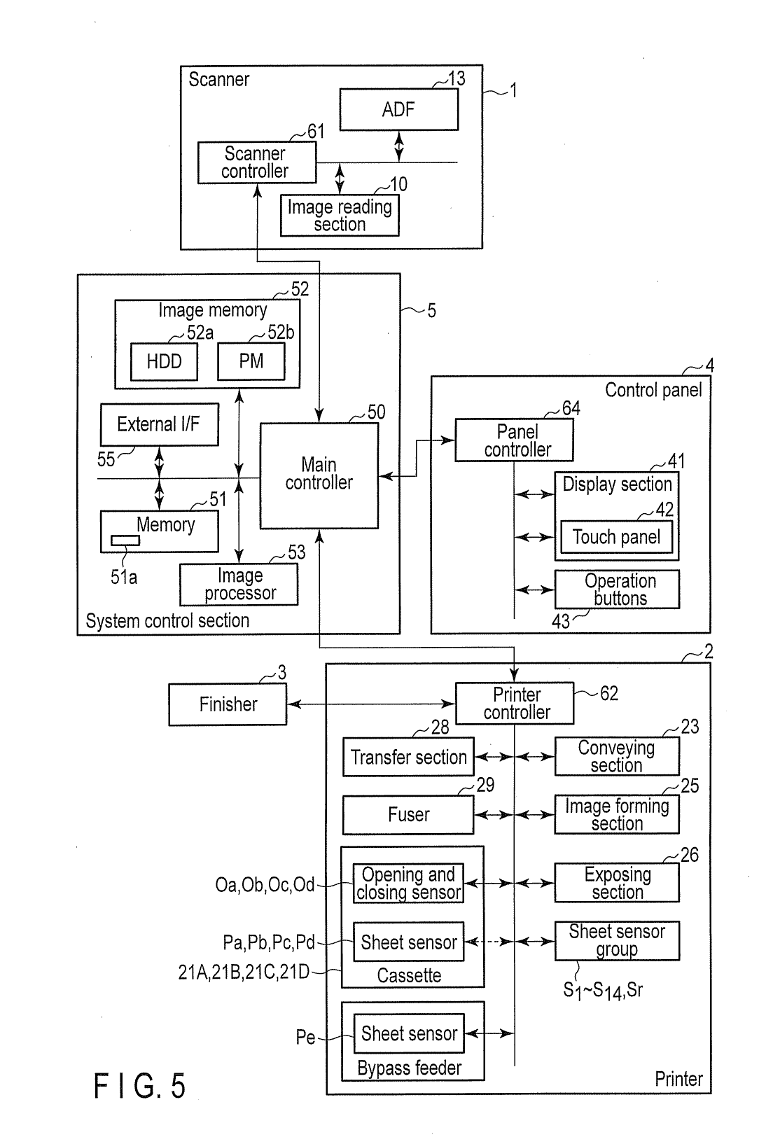

FIG. 5 is a block diagram for explaining a configuration example of the control system in the digital multi-functional peripheral.

The digital multi-functional peripheral includes a system control section 5 configured to control the entire apparatus. The system control section 5 is connected to the scanner 1, the printer 2, the finisher 3, and the control panel 4. The system control section 5 collectively controls the scanner 1, the printer 2, the finisher 3, and the control panel 4.

The system control section 5 includes a main controller (a processor) 50, an image memory 52, an image processor 53, a memory 51, and an external interface (external I/F) 55.

The main controller 50 controls the entire digital multi-functional peripheral. The main controller 50 includes, for example, a processor, a RAM, and a ROM. In the main controller 50, a processor executes computer programs stored in a memory such as the ROM or a memory 51 to thereby realize various kinds of processing. The main controller 50 is connected to control sections of the scanner 1, the printer 2, the control panel 4, and the like. The main controller 50 outputs operation instructions to the sections and acquires various kinds of information from the sections according to two-way communication with the scanner 1, the printer 2, and the control panel 4. For example, the main controller 50 outputs setting information to the sections on the basis of present effective setting content. The main controller 50 inputs information indicating detection signals of the sensors, operation states, and the like from the sections.

The memory 51 is a rewritable nonvolatile memory. The memory 51 stores various data related to the operation of the digital multi-functional peripheral. The memory 51 stores computer programs and control data for the processor of the main controller 50 to perform processing for controlling the operations of the sections. For example, the memory 51 stores a display control program for controlling display content to be displayed on the display device 41 and stores display data to be displayed on the display device 41 (e.g., display data of guidance explained later).

The memory 51 stores information indicating operation states of the sections. For example, the memory 51 stores information for determining degrees of use or degrees of deterioration concerning various consumable components. The life of each of the consumable components is determined according to information stored in the memory 51. For example, the memory 51 according to this embodiment includes a counter 51a for determining the life of rollers of a paper feeding system for feeding sheets from each of the cassettes 21A, 21B, 21C, and 21D or the bypass feeder Bf. The counter 51a stores, for each of the cassettes 21A, 21B, 21C, and 21D and the bypass feeder Bf, a count value obtained by counting the number of fed sheets. For example, the main controller 50 counts up, every time one sheet is fed, a count value corresponding to the cassette 21 or the bypass feeder Bf from which the sheet is fed.

The image memory 52 includes a hard disk drive (HDD) 52a and a page memory (PM) 52b. The HDD 52a is a large-capacity storage device. For example, the HDD 52a stores plural image data. Setting data other than the image data, a control program, and the like may be stored in the HDD 52a. The page memory 52b is a memory for expanding image data to be processed. The image processor 53 processes the image data. The image processor 53 corrects, compresses, or de-compresses the image data. The external interface 55 is an interface configured to perform data communication with an external apparatus. For example, the external interface 55 receives the input of image data for print from the external apparatus.

The scanner 1 includes a scanner controller 61. The scanner controller 61 can communicate with the main controller 50 of the system control section 5. The scanner controller 61 controls the image reading section 10 and the ADF 13. The processor executes the control program stored in the memory, whereby the scanner controller 61 controls the sections in the scanner 1. The scanner controller 61 outputs image data read by the image reading section 10 to the system control section 5.

The printer 2 includes a printer controller 62. The printer controller 62 can communicate with the main controller 50 of the system control section 5. The printer controller 62 controls the conveying section 23, the image forming sections 25, the exposing section 26, the transfer section 28, and the fuser 29 in the printer 2. The processor executes the control program stored in the memory, whereby the printer controller 62 controls the sections in the printer 2. The printer controller 62 can communicate with a finisher controller 63 of the finisher 3. The printer controller 62 outputs an operation instruction to the finisher 3 and acquires various kinds of information from the finisher 3.

The printer controller 62 notifies the main controller 50 of the system control section 5 of a processing state detected by the sensors set in the sections in the printer 2. For example, the printer controller 62 outputs detection signals by the opening and closing sensors Oa, Ob, Oc, and Od provided in each of the cassettes 21A, 21B, 21C, and 21D to the main controller 50 as information indicating opening and closing states of each of the cassettes 21A, 21B, 21C, and 21D. The printer controller 62 outputs detection signals by the sheet sensors Pa, Pb, Pc, and Pd provided in each of the cassettes 21A, 21B, 21C, and 21D to the main controller 50 as information indicating presence or absence of sheets in each of the cassettes 21A, 21B, 21C, and 21D. The printer controller 62 outputs a detection signal by the sheet sensor Pe provided in the bypass feeder Bf to the main controller 50 as information indicating presence or absence of sheets in the bypass feeder Bf.

The printer controller 62 outputs detection signals by the sheet sensors S1 to S14, Sr, and the like provided in the sections of the conveying paths for conveying sheets, on which image are formed, to the main controller 50 as information indicating conveyance states of the sheets in the conveying paths. For example, the main controller 50 or the printer controller 62 detects a skew of a conveyed sheet according to detection results of the sheet sensors S1 to S14 functioning as the skew detection sensors. The main controller 50 or the printer controller 62 controls conveyance timing for transferring an image onto a sheet according to a detection signal of the sheet sensor Sr functioning as a registration sensor provided before the registration roller 24.

The control panel 4 includes a panel controller 64. The panel controller 64 can communicate with the main controller 50 of the system control section 5. The panel controller 64 is connected to the display device 41, the touch panel 42, and the operation buttons 43. The panel controller 64 controls a display screen displayed by the display device 41. The panel controller 64 detects a display region such as an icon touched by the user according to a detection signal from the touch panel 42. The panel controller 64 outputs information indicating the icon touched by the user to the main controller 50. The panel controller 64 outputs a signal indicating the operation button 43 pressed by the user to the main controller 50.

A jam that occurs in the digital multi-functional peripheral is explained.

In the digital multi-functional peripheral, a sheet jam could occur in the printer 2. Sheet jams can be roughly classified into several types. Examples of the jams include a paper feed jam that occurs if a sheet is fed from the cassette 21 or the bypass feeder Bf and a skew-related jam that occurs during conveyance because of a conveyance state of a sheet such as a skew.

The paper feed jam occurs because sheets cannot be normally fed from the cassette 21 (21A, 21B, 21C, or 21D) or the bypass feeder Bf or cannot be separated. As a cause of the paper feed jam, a way of setting sheets in the cassette 21 or the bypass feeder Bf, a state of the rollers of the paper feeding system for feeding sheets (e.g., the life of the paper feeding rollers runs out), or the like is conceivable. Since the cause of the paper feed jam is not limited to one, it is difficult for the user to grasp a cause of the paper feed jam every time the paper feed jam occurs.

For example, the paper feed jam caused by the way of setting sheets tends to occur if the position of sheet setting is not correct or if sheets are not set by a method corresponding to a characteristics of the sheets (e.g., a coefficient of friction among the sheets is high). Concerning special sheets such as a postcard, a small sheet, coat paper, label paper, and long paper, a technique and attention different from those for plain paper are often necessary if the special sheets are set in the cassette 21 or the bypass feeder Bf.

It is not easy for the user to remember beforehand correct setting methods corresponding to characteristics of various sheets. In general, the user learns a method of setting sheets in the cassette 21 and the bypass feeder Bf from a user's manual or a label affixed near the cassette 21 or the bypass feeder Bf (e.g., a label affixed on the upper surface of the cassette). However, it is not easy for the user to check the sheet setting method described in the user's manual or the label every time the user actually sets sheets.

It is possible to detect a sheet size with the sensors provided in the cassettes 21 and the bypass feeder Bf, determine whether a document size and the sheet size coincide with each other, and determine whether a size of actually set sheets and sheet setting coincide with each other. After a fed sheet is conveyed, it is also possible to detect a skew in the sheet under conveyance with the skew detection sensors. However, the paper feed jam could occur because of not only the sheet setting method but also a state of the rollers of the paper feeding system (the life of the rollers runs out). It is difficult for the user to grasp whether sheets are correctly set before starting printing and accurately grasp a cause of the occurred paper feed jam.

Sheet set guidance indicating a sheet setting method is explained.

The digital multi-functional peripheral displays, on the display section 41, sheet set guidance for informing the user of a correct sheet setting method in the cassette 21 or the bypass feeder Bf to reduce the paper feed jam. For example, the digital multi-functional peripheral not only displays guidance for, if the paper feed jam occurs, releasing the jam (jam release guidance) but also displays sheet set guidance for informing the user of a correct setting method for sheets. The sheet set guidance may be displayed not only if the paper feed jam is released but also if sheets are set.

According to such sheet set guidance, it is possible to urge the user to correctly set sheets and it is possible to expect an effect of reducing the paper feed jam. However, the sheet set guidance does not need to be always displayed if a jam occurs. For example, the main controller 50 may display the sheet set guidance on the display section 41 if jams likely to be caused by a sheet setting method frequently occur.

Display processing for displaying the sheet set guidance if sheets are set in the cassette 21 or the bypass feeder Bf is explained.

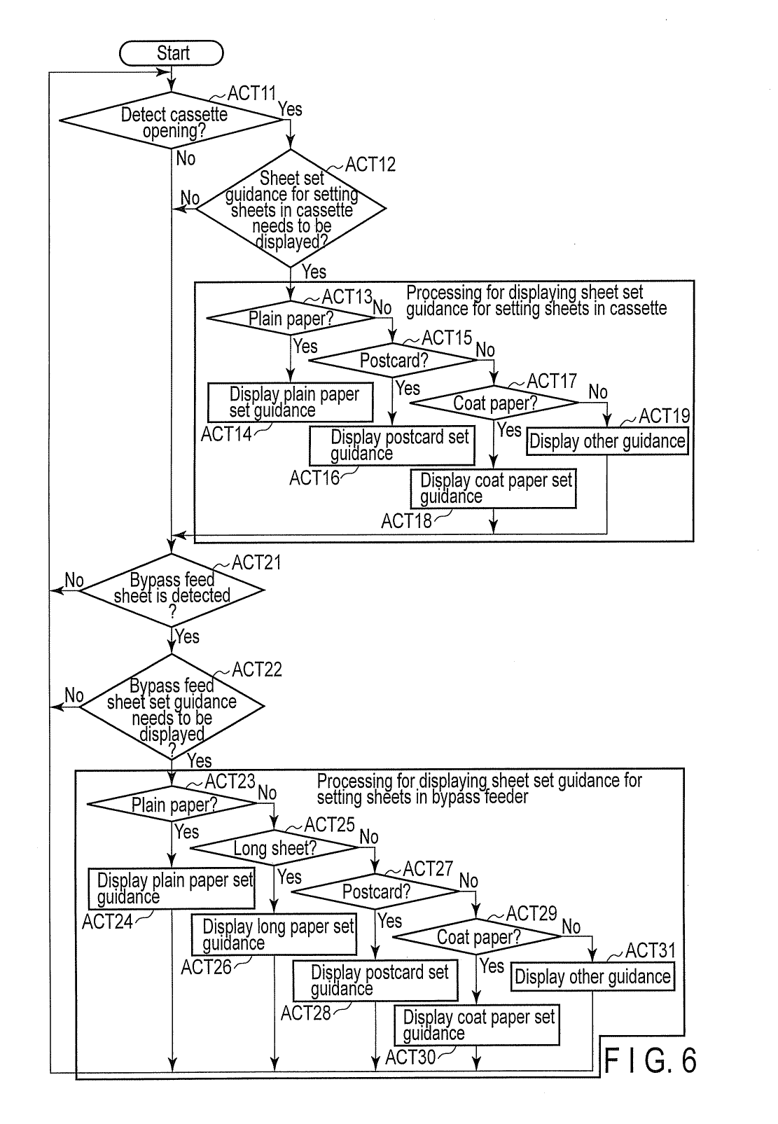

FIG. 6 is a flowchart for explaining an example of display processing for displaying the sheet set guidance on the display section 41 if sheets are set in the cassette 21 or the bypass feeder Bf. As shown in FIG. 6, if sheets are set in the cassette 21 or the bypass feeder Bf, the display section 41 displays the sheet set guidance corresponding to a type of the sheets.

The printer controller 62 monitors opening and closing states of each of the cassettes 21A, 21B, 21C, and 21D according to detection outputs of the opening and closing sensors Oa, Ob, Oc, and Od. If it is detected that any one of the cassettes is opened, the printer controller 62 notifies the main controller 50 that the cassette is opened. If the cassette 21 is opened (YES in ACT 11), the main controller 50 determines whether it is necessary to display the sheet set guidance for informing the user of a correct method of setting sheets in the opened cassette (ACT 12). For example, it may be set in advance whether the sheet set guidance for a cassette is displayed according to the opening of the cassette.

The sheet set guidance for a cassette may be displayed according to conditions other than opening of the cassette. For example, the sheet set guidance may be displayed if the cassette is opened and sheets are absent in the cassette. The sheet set guidance may be displayed if the setting of sheets stored in the cassette is changed. The sheet set guidance may be displayed if the cassette is opened immediately after the setting of sheets stored in the cassette is changed.

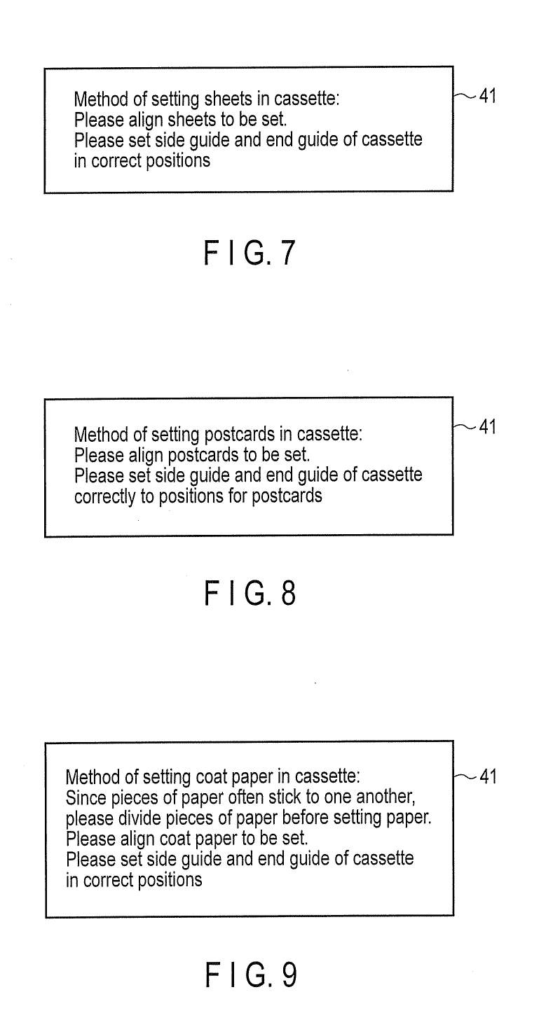

If the main controller 50 determines that the sheet set guidance for the cassette is displayed (YES in ACT 12), the main controller 50 determines a type of sheets stored in the opened cassette (set sheets). If the sheets stored in the cassette are plain paper (YES in ACT 13), the main controller 50 displays, on the display section 41, guidance indicating a method of correctly setting the plain paper in the cassette (ACT 14). FIG. 7 is a diagram of a display example of the plain paper set guidance indicating the method of correctly setting the plain paper in the cassette. In the display example shown in FIG. 7, the display section 41 displays to the effect that the user aligns sheets to be set and sets a side guide and an end guide in the cassette in correct positions.

If the sheets stored in the cassette are postcards (YES in ACT 15), the main controller 50 displays, on the display section 41, a method of correctly setting the postcards in the cassette (ACT 16). FIG. 8 is a diagram of a display example of postcard set guidance indicating the method of correctly setting the postcards in the cassette. In the display example shown in FIG. 8, the display section 41 displays to the effect that the user aligns the postcards to be set and correctly sets the side guide and the end guide in the cassette in positions for the postcards.

If the sheets stored in the cassette are coat paper (YES in ACT 17), the main controller 50 displays, on the display section 41, guidance indicating a method of correctly setting the coat paper in the cassette (ACT 18). FIG. 9 is a diagram of a display example of coat paper set guidance indicating a method of correctly setting the coat paper in the cassette. In the display example shown in FIG. 9, the display section 41 displays to the effect that, since pieces of paper often stick to one another, the user divides (once separates) the pieces of paper before setting the paper, aligns the coat paper to be set, and sets the side guide and the end guide in the cassette in correct positions.

If the sheets stored in the cassette are none of the plain paper, the postcards, and the coat paper (YES in ACT 19), the main controller 50 also displays, on the display section 41, guidance indicating a method of correctly setting the sheets in the cassette (ACT 20). Specifically, as display processing for the sheet set guidance for the cassette, the main controller 50 sets in advance kinds of sheet set guidance corresponding to a combination of each of the cassettes and types of sheets and displays, on the display section 41, sheet set guidance corresponding to the opened cassette and a type of sheets set in the opened cassette. Concerning a sheet of a type for which specific sheet set guidance is not prepared in advance, the main controller 50 may display sheet set guidance indicating a general method of setting sheets in a cassette like the plain paper set guidance.

If sheets are set in the bypass feeder Bf, the sheet sensor Pe supplies a detection signal indicating that the sheets are set to the printer controller 62. If the sheet sensor Pe detects the sheets, the printer controller 62 notifies the main controller 50 that the sheets are placed on the bypass feeder Bf. If the sheets are placed on the bypass feeder Bf (YES in ACT 21), the main controller 50 determines whether it is necessary to display sheet set guidance for informing the user of a correct method of setting the sheets in the bypass feeder Bf (ACT 22). For example, it only has to be set in advance whether the sheet set guidance for the bypass feeder Bf is displayed if sheets are placed on the bypass feeder Bf.

Timing for displaying the sheet set guidance for the bypass feeder Bf is not limited to timing when the sheets are placed on the bypass feeder Bf. For example, if the sheets are placed on the bypass feeder Bf, the main controller 50 may display, on the display section 41, a selection screen for selecting a type of the sheets to be set. In this case, the main controller 50 only has to display the sheet set guidance on the display 41 if a type of the sheets to be set is selected. The main controller 50 may display the sheet set guidance if the user selects the bypass feeder Bf as a paper feeding place for the sheets.

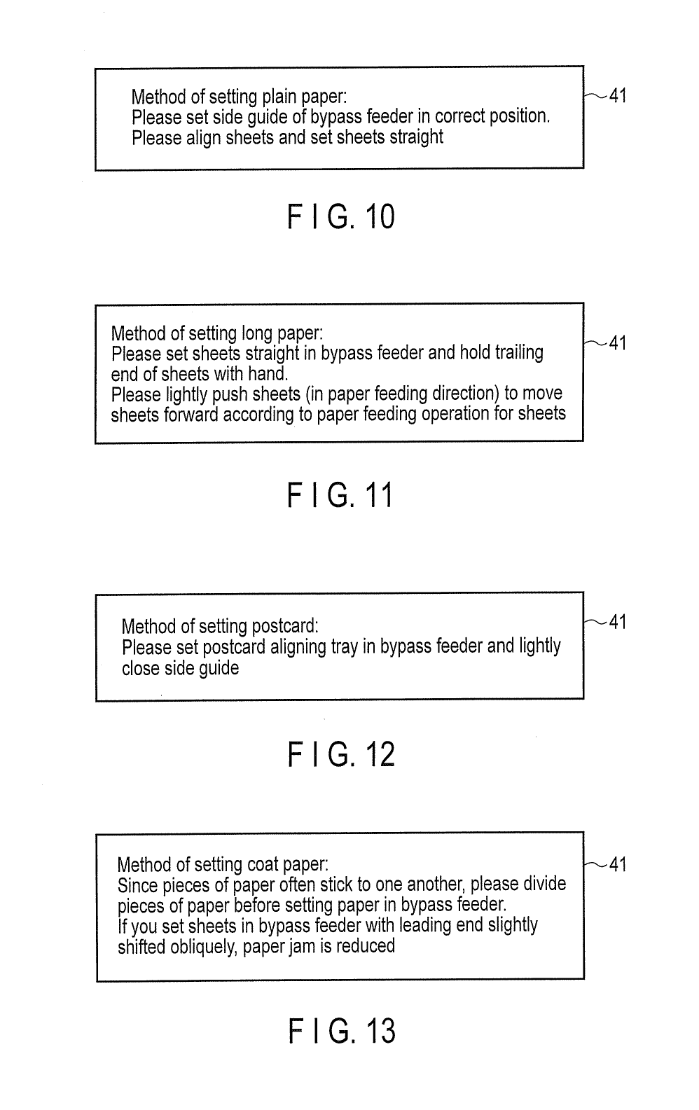

If the main controller 50 determines that the sheet set guidance for the bypass feeder Bf is displayed (YES in ACT 22), the main controller 50 determines a type of the sheets to be set in the bypass feeder Bf (set sheets). If the sheets to be set in the bypass feeder are plain paper (YES in ACT 23), the main controller 50 displays, on the display section 41, guidance indicating a method of correctly setting the plain paper in the bypass feeder Bf (ACT 24). FIG. 10 is a diagram of a display example of plain paper set guidance indicating the method of correctly setting the plain paper in the bypass feeder Bf. In the display example shown in FIG. 10, the display section 41 displays to the effect that the user sets a sheet guide provided in the bypass feeder Bf in a correct position and aligns and sets the sheets straight.

If the sheets to be set in the bypass feeder Bf is long paper (YES in ACT 25), the main controller 50 displays, on the display section 41, guidance indicating a method of correctly setting the long paper in the bypass feeder Bf (ACT 26). FIG. 11 is a diagram of a display example of long paper set guidance indicating the method of correctly setting the long paper in the bypass feeder Bf. In the display example shown in FIG. 11, the display section 41 displays to the effect that user sets the sheets straight in the bypass feeder Bf and holds the trailing end of the sheets by hand and that the user lightly pushes the sheets in a paper feeding direction to move the sheets forward according to a paper feeding operation for the sheets.

If the sheets to be set in the bypass feeder Bf are postcards (YES in ACT 27), the main controller 50 displays, on the display section 41, guidance indicating a method of correctly setting the postcards in the bypass feeder Bf (ACT 28). FIG. 12 is a diagram of a display example of postcard set guidance indicating the method of correctly setting the postcards in the bypass feeder Bf. In the display example shown in FIG. 12, the display section 41 displays to the effect that the user sets a postcard aligning tray in the bypass feeder Bf and lightly closes a side guide.

If the sheets to be stored in the bypass feeder Bf is coat paper (YES in ACT 29), the main controller 50 displays, on the display section 41, guidance indicating a method of correctly setting the coat paper in the bypass feeder Bf (ACT 30). FIG. 13 is a diagram of a display example of coat paper set guidance indicating the method of correctly setting the coat paper in the bypass feeder Bf. In the display example shown in FIG. 13, the display section 41 displays to the effect that, since pieces of paper often stick to one another, the user divides the pieces of paper before setting the paper and, if the user sets the sheets in the bypass feeder Bf with the leading end of the sheets slightly shifted obliquely, a sheet jam is reduced.

If the sheets to be set in the bypass feeder Bf are none of the plain paper, the long paper, the postcards, and the coat paper (YES in ACT 31), the main controller 50 displays, on the display section 41, guidance indicating a method of correctly setting the sheets in the bypass feeder Bf according to a type of the sheets (ACT 32). Specifically, as display processing for the sheet set guidance for the bypass feeder Bf, the main controller 50 sets in advance, for each type of sheets, kinds of sheet set guidance for the bypass feeder Bf and displays, on the display section 41, sheet set guidance corresponding to a type of sheets set in the bypass feeder Bf. Concerning a sheet of a type for which specific sheet set guidance is not prepared in advance, the main controller 50 may display sheet set guidance indicating a general method of setting sheets in a bypass feeder like the plain paper set guidance.

In the processing explained above, if the user sets sheets in the cassette (if the user opens the cassette), the sheet set guidance corresponding to a type of the sheets is displayed on the display section 41 as guidance for a method of correctly setting the sheets in the cassette. If the user sets sheets in the bypass feeder Bf (if the user places sheets on the bypass feeder Bf), the sheet set guidance corresponding to a type of the sheets is displayed on the display section 41 as guidance for a method of correctly setting the sheets in the bypass feeder Bf. According to such processing, if sheets are set, it is possible to inform the user of an appropriate sheet set method corresponding to a type of the sheets and a paper feeding stage and convenience is improved.

Processing performed if a jam occurs during printing is explained.

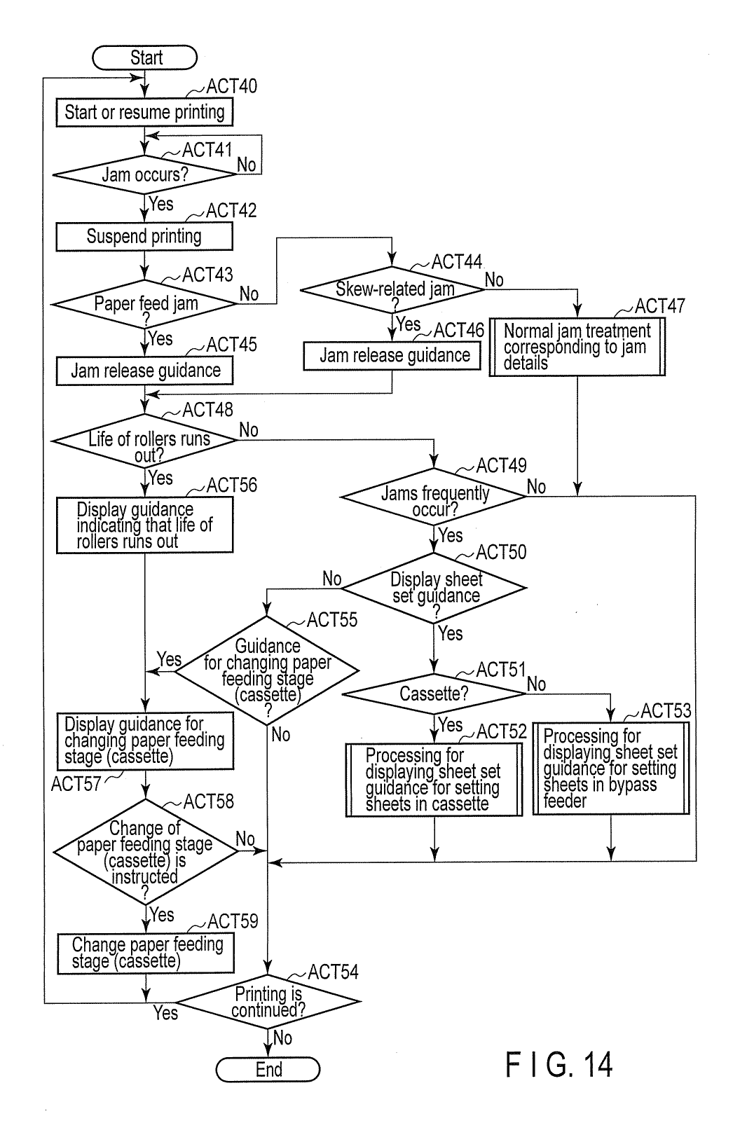

FIG. 14 is a flowchart for explaining a processing example performed if a jam occurs during printing.

If printing is started (ACT 40), the main controller 50 detects, according to information from the printer controller 62, whether a jam occurs. The printer controller 62 monitors conveyance states of sheets according to detection signals from the sensors set in the places in the printer 2 such as the sensors S1 to S14 and Sr (ACT 41). For example, the printer controller 62 monitors, with reference to paper feeding timing, a conveyance state of a fed sheet according to whether the sensors detect the sheet at desired timing. For example, if the sheet cannot be detected at the desired timing, the printer controller 62 determines that a jam of the sheet occurs.

If the printer controller 62 determines that the jam occurs (ACT 41), the printer controller 62 suspends the printing (ACT 42) and notifies the main controller 50 of detection results of each of the sensors indicating a state of the occurrence of the jam. If the jam occurs, the main controller 50 determines, according to information supplied from the printer controller 62, whether the jam is a paper feed jam, a skew-related jam, or a jam other than the paper feed jam and the skew-related jam (ACTS 43 and 44). For example, the printer controller 62 notifies the main controller 50 of an error code indicating a state of the occurred jam. In this case, the main controller 50 determines a type of the jam according to the error code notified from the printer controller 62.

The paper feed jam is a jam that occurs in the cassette 21 set as a paper feeding stage or the bypass feeder Bf. For example, if the sheet sensor provided immediately behind the cassette 21 set as the paper feeding stage or the bypass feeder Bf cannot detect a sheet (i.e., detects that a sheet cannot be fed) or a state in which the sheet sensor provided immediately behind the paper feeding roller detects a sheet continues for a predetermined time or more (i.e., the sheet sensor detects that the sheet stays near the paper feeding roller), the printer controller 62 determines that the jam is the paper feed jam.

The skew related jam is a jam that occurs because of a skew of a sheet fed from the cassette 21 set as the paper feeding stage or the bypass feeder Bf. The skew of the fed sheet is detected during conveyance of the sheet on the basis of detection timing of the sheet by the plural sheet sensors functioning as the skew detection sensor. If the sheet, the skew of which is detected by the skew detection sensor, causes a jam, the printer controller 62 determines that the jam is the skew-related jam. The printer controller 62 may determine that the jam is the skew-related jam without using a detection result by the skew detection. For example, the main controller 50 may acquire in advance an error code notified when a sheet, a skew of which is intentionally caused, causes a jam and determine the error code as an error code of the skew-related jam.

As the skew-related jam, it is assumed that a sheet after passing though the paper feeding roller causes a jam because of a skew that occurs during paper feeding from the cassette 21 or the bypass feeder Bf. As a phenomenon example, a jam could occur because timing for detecting the sheet with the sensors provided behind the registration roller is delayed because of the skew that occurs during the paper feeding. This is because, since skew correction cannot be performed by the registration roller, if the sheet tilts, the timing for detecting the sheet by the sensors behind the registration roller is delayed (in most cases, the sensors are set near the center of the conveying path for the sheet). In conveyance control for the sheet before the registration roller, to prevent the sheet from colliding with the preceding or following sheet, control could be performed to start conveyance of the next sheet at timing when the sensors are turned off by the preceding sheet. Even in such conveyance control, if a skew occurs, conveyance timing for the sheet could be delayed to cause a jam.

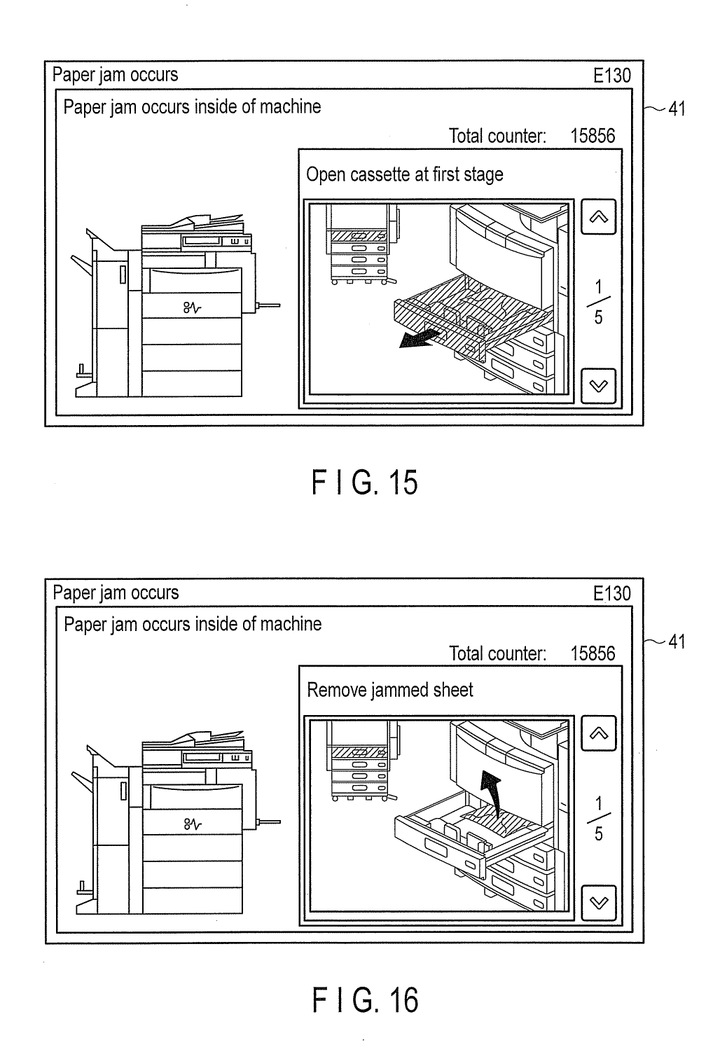

If the main controller 50 determines that the occurred jam is the paper feed jam (YES in ACT 43), the main controller 50 displays, on the display section 41, jam release guidance for releasing the jam (the paper feed jam) (ACT 45). FIGS. 15 and 16 are diagrams of examples of jam release guidance displayed if, as an example of the paper feed jam, the paper feed jam occurs in the cassette 21A at a first stage. The jam release guidance shown in FIG. 15 automatically transitions to the jam release guidance shown in FIG. 16. For example, if the opening and closing sensor Oa detects opening of the cassette 21, the main controller 50 transitions the jam release guidance shown in FIG. 15 to the jam release guidance shown in FIG. 16.

Immediately after a jam occurs, as shown in FIG. 15, the main controller 50 displays, on the display section 41, a place of the occurrence of the jam and first work (first operation) as first jam release guidance. In the jam release guidance shown in FIG. 15, the main controller 50 displays content for informing the user that the place of the occurrence of the jam is the cassette 21A at the first stage and the cassette 21A, which is the place of the occurrence of the jam, is to be opened. If operation informed by the first jam release guidance is carried out (if the cassette 21A is opened), as shown in FIG. 16, the main controller 50 displays, on the display section 41, guidance for work (second operation) for releasing the jam as second jam release guidance. In the jam release guidance shown in FIG. 16, the main controller 50 displays guidance for work for removing a jammed sheet from the cassette 21A as the second operation.

If the main controller 50 determines that the occurred jam is the paper feed jam, the main controller 50 checks the life of the rollers (a paper feeding mechanism) of the paper feeding system including the paper feeding rollers (ACT 48). For example, the main controller 50 checks the life of the paper feeding rollers by comparing a counter value indicating the number of times of operation of each of the paper feeding rollers counted by the counter 51a of the memory 51 and a reference value of the life for each of the paper feeding rollers. In other words, the main controller 50 determines whether the count value of the paper feeding rollers in the counter 51a exceeds the life reference value.

If the roller of the paper feeding system and the pickup roller 22Ep for picking up a sheet are present as in the bypass feeder Bf shown in FIG. 2, the main controller 50 checks the life concerning not only the paper feeding roller 22E but also the pickup roller 22Ep. In other words, in ACT 48, the main controller 50 checks the life concerning each of the rollers (the paper feeding mechanism) of the paper feeing system in a paper feeding stage at a paper feeding source of the jammed sheet.

If the main controller 50 determines that the life of the rollers of the paper feeding system does not run out (NO in ACT 48), the main controller 50 checks whether the paper feed jam and the skew-related jam frequently occur in the paper feeding stage (the cassette 21 or the bypass feeder Bf) (ACT 49). For example, the main controller 50 stores the number of times of occurrence of jams in the memory 51 every time the paper feed jam and the skew-related jam in the paper feeding stage occur. The main controller 50 determines, according to whether the number of times of the paper feed jam and the skew-related jam in the paper feeding stage is equal to or larger than a reference value, whether the paper feed jam frequently occurs in the paper feeding stage.

If the main controller 50 determines that the paper feed jam and the skew-related jam frequently occur, the main controller 50 displays the sheet set guidance or informs the user of a change to another paper feeding stage. In other words, the reference value for determining whether the paper feed jam frequently occurs can be considered a reference value for determining whether the sheet set guidance is displayed or guidance to a change of a cassette is performed.

If the main controller 50 determines that the paper feed jam and the skew-related jam frequency occur (YES in ACT 49), the main controller 50 determines whether the sheet set guidance is displayed following the jam release guidance (ACT 45). If the main controller 50 determines that the sheet set guidance is displayed (YES in ACT 50), the main controller 50 determines whether a paper feeding stage in which the paper feed jam occurs is the cassette 21 or the bypass feeder Bf (ACT 51). If the paper feeding stage in which the paper feed jam occurs is the cassette 21 (YES in ACT 51), the main controller 50 performs display processing for the sheet set guidance for the cassette 21 (ACT 52). The display processing for the sheet set guidance for the cassette 21 may be processing same as the processing in ACTS 13 to 19 shown in FIG. 6. If the paper feeding stage in which the paper feed jam occurs is the bypass feeder Bf (NO in ACT 51), the main controller 50 performs display processing for the sheet set guidance for the bypass feeder Bf (ACT 53). The display processing for the sheet set guidance for the bypass feeder Bf may be processing same as the processing in ACTS 23 to 30 shown in FIG. 6.

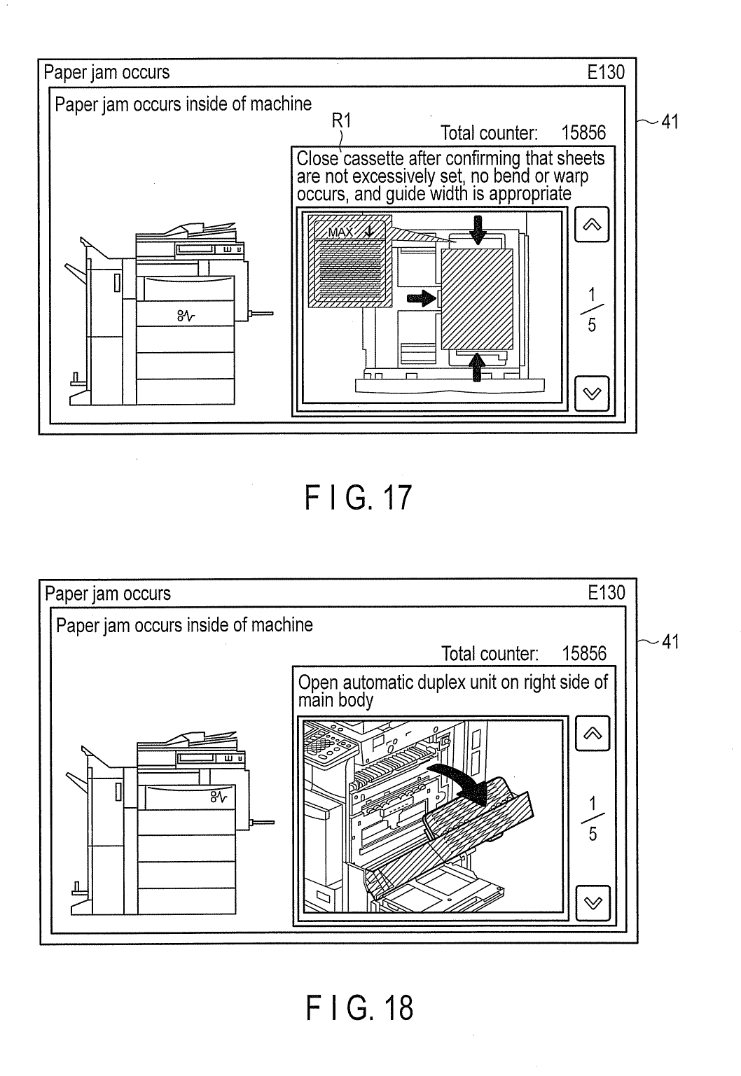

However, in the processing shown in FIG. 14, the display processing in ACT 52 or ACT 53 is processing for displaying the sheet set guidance following the jam release guidance. In other words, the sheet set guidance displayed in the display processing in ACT 52 or ACT 53 is displayed on the display section 41 as a display screen transitioned from the jam release guidance. For example, FIG. 17 is a diagram of a display example of the sheet set guidance transitioned from the jam release guidance shown in FIG. 16.

In the display example shown in FIG. 17, from the display screen shown in FIG. 16, display content in a guidance display area R1 is changed to content for informing the user of a sheet set method and display content in an image area R2 is changed to an image showing a state in which sheets are correctly set. FIG. 17 is a diagram of a display example for informing the user of a method of setting plain paper in a cassette. Concerning sheets of other types, the display section 41 may change the display contents in the display area R1 and the image area R2 to display contents corresponding to the types of the sheets to thereby transition the display contents from the jam release guidance to the sheet set guidance.

As guidance shown in FIGS. 15, 16, and 17, in each operation stage, the main control section 50 enhances the display portion which shows contents of work in which a user should operate. The main control section 50 may display the enhanced display portion, as a different specific color from others, for example. Moreover, the main control section 50 may display the enhanced display portions in white, and may display other portions in gray. According to such guidance, a user's work portion and contents of work in each operation stage are intelligible.

The main controller 50 determines timing for transitioning the jam release guidance to the sheet set guidance. If the main controller 50 detects that the jam is removed or if a predetermined time elapses after the jam release guidance is displayed, the main controller 50 transitions the jam release guidance to the sheet set guidance. For example, if the main controller 50 detects, with a human sensor or a distance measurement sensor, that a hand approaches the cassette in which the paper feed jam occurs, the display section 41 may transition the display content of the display section from the jam release guidance to the sheet set guidance.

After displaying the sheet set guidance in ACT 52 or ACT 53, the main controller 50 checks whether the printing is continued (resumed) according to selection by the user (ACT 54). If the main controller 50 determines that the paper feed jam does not frequently occur (NO in ACT 49), the main controller 50 also checks whether the printing is continued (ACT 54). If the user selects continuation of the printing through the control panel 4, the main controller 50 determines to continue (resume) the printing. If the main controller 50 determines to continue the printing (YES in ACT 54), the main controller 50 returns to ACT 40 and resumes the printing. If the user selects suspension (end) of the printing through the control panel 4, the main controller 50 determines to end the printing. If the main controller 50 determines to end the printing (NO in ACT 54), the main controller 50 ends the printing.

If the main controller 50 determines that the occurred jam is the skew-related jam (YES in ACT 44), the main controller 50 displays, on the display section 41, the jam release guidance for releasing the jam (the skew-related jam) (ACT 46). The order of displaying the jam release guidance is basically the same as the jam release guidance for the paper feed jam. However, since the skew-related jam is a jam that occurs in the conveying paths after paper feeding (a jam in the printer 2), specific content displayed as the jam release guidance is different.

As guidance shown in FIGS. 18, 19, 20, 21, and 22, in each operation stage, the main control section 50 enhances the display portion which shows contents of work in which a user should operate. The main control section 50 may display the enhanced display portion, as a different specific color from others, for example. Moreover, the main control section 50 may display the enhanced display portions in white, and may display other portions in gray. According to such guidance, a user's work portion and contents of work in each operation stage are intelligible.

For example, FIGS. 18, 19, 20, 21, and 22 show an example of the jam release guidance for a jam that occurs in the conveying paths in the main body of the printer 2 as an example of the skew-related jam. FIGS. 18, 19, 20, 21, and 22 are diagrams of a series of the jam release guidance displayed to transition in order. The main controller 50 detects states of a unit, a cover, a lever, or the like with the sensors and displays, on the basis of a result of the detection, contents conforming to a jam release procedure in the order shown in FIGS. 18, 19, 20, 21, and 22.

For example, immediately after a jam occurs, the main controller 50 displays the first jam release guidance on the display section 41. In an example of the first jam release guidance shown in FIG. 18, the main controller 50 informs the user to open a unit (an automatic duplex unit) on the right side of the main body of the apparatus. The automatic duplex unit is not shown in the configuration example of FIG. 2. Opening and closing of the automatic duplex unit may be detected by the sensors or the like.

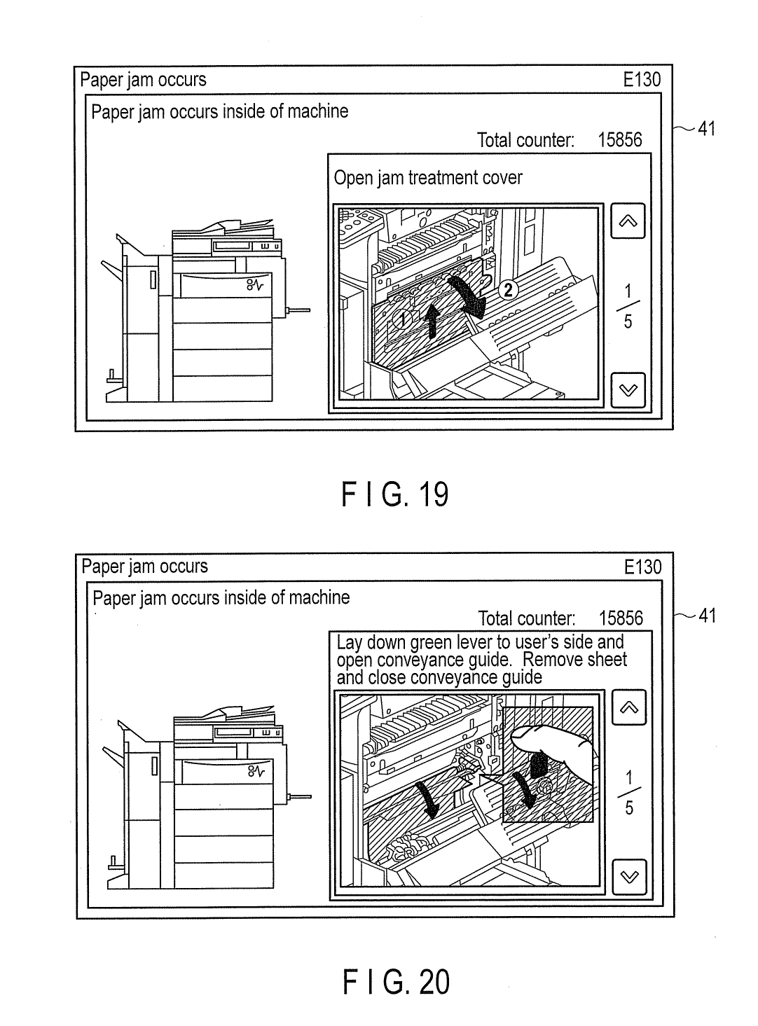

If the work informed by the first jam release guidance (in an example shown in FIG. 18, opening of the automatic duplex unit) is executed, the main controller 50 displays the second jam release guidance on the display section 41. In an example of the Second jam release guidance shown in FIG. 19, the main controller 50 informs the user to open a jam treatment cover.

If the work informed by the second jam release guidance is executed (in the example shown in FIG. 19, opening of the jam treatment cover), the main controller 50 displays a third jam release guidance on the display section 41. In the example of the third jam release guidance shown in FIG. 20, the main controller 50 informs the user to lay down a green lever to the user's side to open a conveyance guide and close the conveyance guide after the sheet is removed.

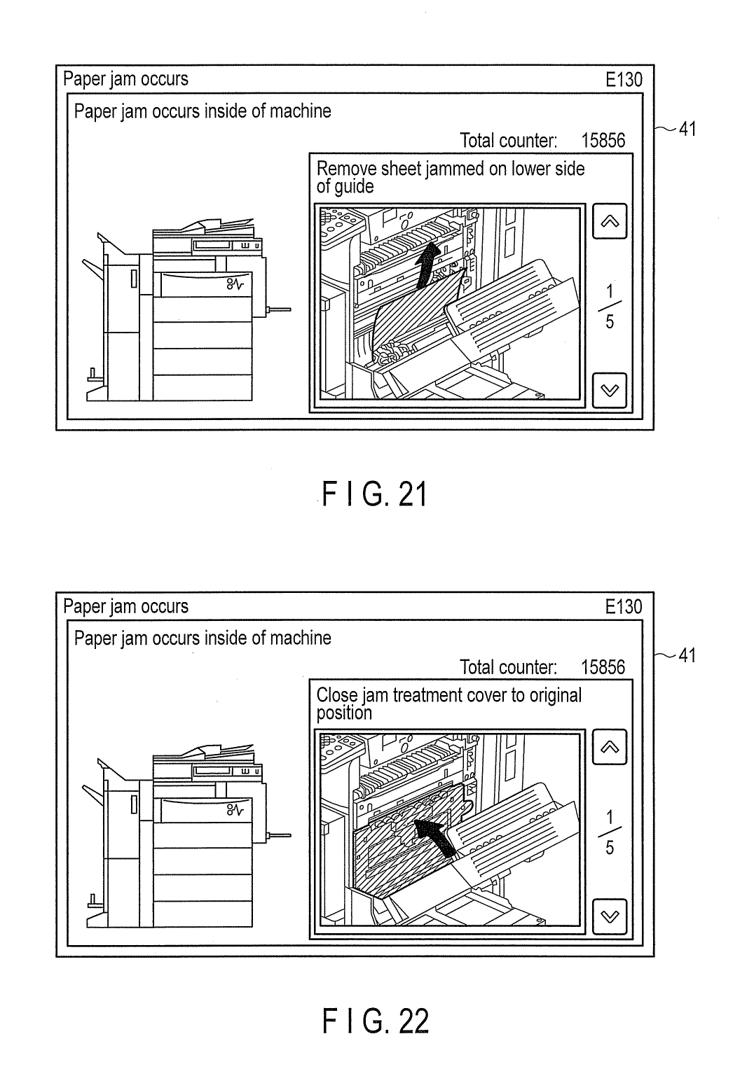

If the work informed by the third jam release guidance (in the example shown in FIG. 20, sheet removal from the conveyance guide) is executed, the main controller 50 display the fourth jam release guidance on the display section 41. In the example of the fourth jam release guidance shown in FIG. 21, the main controller 50 informs the user to remove a sheet clogged on the lower side of the guide.

If the work informed by the fourth jam release guidance (in the example shown in FIG. 19, sheet removal on the lower side of the guide) is executed, the main controller 50 displays the fifth jam release guidance on the display section 41. In the example of the fifth jam release guidance shown in FIG. 22, the main controller 50 informs the user to close the jam treatment cover to an original position.

If the main controller 50 determines that the occurred jam is neither the paper feed jam nor the skew-related jam (NO in ACT 44), the main controller 50 carries out the normal jam treatment corresponding to contents of the jam (ACT 47).

If the main controller 50 determines that the occurred jam is the skew-related jam (YES in ACT 44), the main controller 50 still checks the life of the rollers of the paper feeding system (ACT 48). If the main controller 50 determines that the life of the rollers of the paper feeding system does not run out (NO in ACT 48), the main controller 50 proceeds to ACT 49. Concerning the skew related jam, if the main controller 50 also determines to display the sheet set guidance (YES in ACT 50), the main controller 50 performs display processing for the sheet set guidance for the cassette 21 or the bypass feeder Bf following the jam release guidance for the skew-related jam (ACTS 52 and 53).

If the main controller 50 determines that the life of the rollers (the paper feeding mechanism) of the paper feeding system in the paper feeding stage from which the jammed sheet is fed runs out (YES in ACT 48), the main controller 50 displays, on the display section 41, to the effect that the life of the rollers of the paper feeing system runs out (ACT 56). If the main controller 50 determines that the life of the rollers of the paper feeding system runs out (YES in ACT 48), the main controller 50 further displays, on the display section 41, guidance for changing the paper feeding stage (the cassette 21 or the bypass feeder Bf) from which sheets are fed (ACT 57). For example, if there is another cassette 21 in which sheets same as the sheets stored in the currently-selected cassette are stored, the main controller 50 displays, on the display section 41, guidance for urging a change to the other cassette 21. If there is no other cassette 21 in which sheets same as the sheets stored in the currently-selected cassette are stored, the main controller 50 displays, on the display section 41, guidance for urging a change to the bypass feeder Bf.

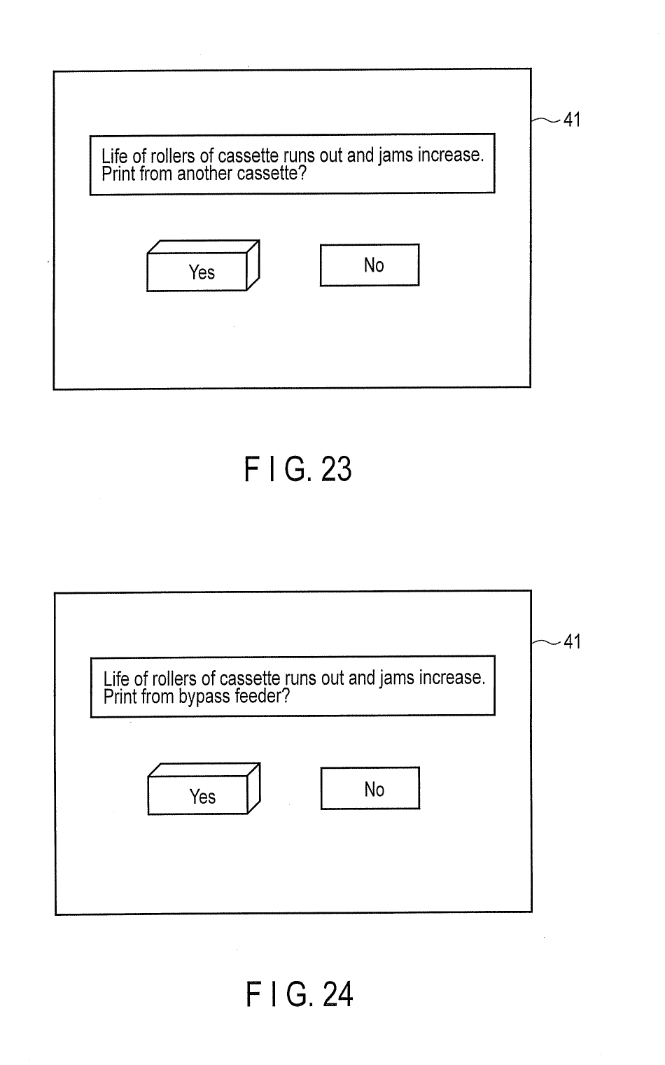

FIG. 23 is a diagram of a display example in which the guidance for urging the user to change the paper feeding stage for sheets to another cassette is displayed together with guidance indicating that the life of the paper feeding roller runs out. FIG. 24 is a diagram of a display example in which the guidance for urging the user to change the paper feeding stage for sheets to the bypass feeder is displayed together with guidance indicating that the life of the paper feeding roller runs out. In the display example shown in FIG. 23, an icon for permitting a change of the paper feeding stage for sheets to another cassette is also displayed. In the display example shown in FIG. 24, an icon for permitting a change of the paper feeding stage for sheets to the bypass feeder is also displayed. Consequently, the user can change, simply by selecting the icon, a cassette, in which the life of a paper feeding roller runs out, to another cassette or the bypass feeder.

If a change of the cassette is instructed according to the guidance shown in FIG. 23 or 24 (YES in ACT 58), the main controller 50 changes the paper feeding stage to another designated cassette 21 or the bypass feeder Bf (ACT 59). After changing the paper feeding stage, the main controller 50 resumes the printing. If a change of the paper feeding stage is not designated (YES in ACT 58), the main controller 50 proceeds to ACT 54 and determines whether the printing is continued or ended.

If the paper feed jam and the skew-related jam frequently occur (YES in ACT 49), the main controller 50 may display cassette change guidance rather than the sheet set guidance (YES in ACT 55). Specifically, if the main controller 50 determines to display the cassette change guide according to the frequent occurrence of the paper feeding jam (ACT 55), the main controller 50 displays, on the display section 41, guidance for changing the setting of the cassette 21 or the bypass feeder Bf from which sheets are fed (ACT 57). For example, if there is another cassette 21 in which sheets same as the sheets stored in the currently-selected cassette 21 are stored, the main controller 50 displays, on the display section 41, guidance for urging a change to the other cassette 21. If there is no other cassette 21 in which sheets same as the sheets stored in the currently-selected cassette 21 are stored, the main controller 50 displays, on the display section 41, guidance for urging a change to the bypass feeder Bf.

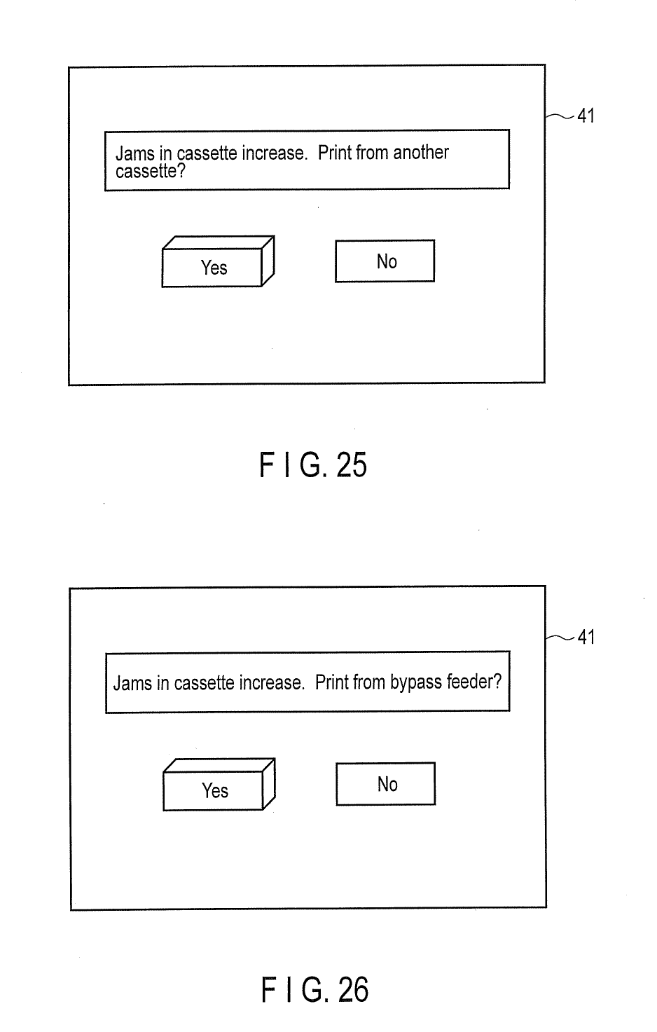

For example, FIG. 25 is a diagram of a display example in which, together with guidance indicating that jams in the cassette increase, the guidance for urging the user to change the paper feeding stage for sheets to another cassette is displayed. FIG. 26 is a diagram of a display example in which, together with guidance indicating that jams in the cassette increase, guidance for urging the user to change the paper feeding stage for sheets to the bypass feeder is displayed. In the display example shown in FIG. 25, an icon for permitting a change of the paper feeding stage for sheets to another cassette is also displayed. In the display example shown in FIG. 26, an icon for permitting a change of the paper feeding stage for sheets to the bypass feeder is also displayed. Consequently, the user can change, simply by selecting the icon, a cassette, in which the paper feed jam frequently occurs, to another cassette or the bypass feeder.

If a change of the cassette is instructed according to the guidance shown in FIG. 25 or 26 (YES in ACT 58), the main controller 50 changes the paper feeding stage to designated another cassette 21 or the bypass feeder Bf (ACT 59). After changing the paper feeding stage, the main controller 50 resumes the printing. If a change of the paper feeding stage is not designated (NO in ACT 58), the main controller 50 proceeds to ACT 54 and determines whether the printing is continued or ended.

In the jam treatment explained above, if the paper feed jam occurs, the display section 41 displays, following the jam release guidance, the sheet set guidance for informing the user of the method of correctly setting sheets in the cassette 21 or the bypass feeder Bf. According to such jam treatment, if the paper feed jam occurs, in addition to the guidance for releasing the jam, it is possible to inform the user of the method of correctly setting sheets in the paper feeding stage. The sheet set guidance may be displayed if the paper feed jam frequently occurs. Consequently, if the paper feed jam frequently occurs, it is possible to inform the user of the method of correctly setting sheets.

In the jam treatment, if the skew-related jam occurs, the display section 41 displays, following the jam release guidance, the sheet set guidance for informing the user of the method of correctly setting sheets in the cassette 21 or the bypass feeder Bf. According to such jam treatment, if the skew-related jam occurs, in addition to the guidance for releasing the jam, it is possible to inform the user of the method of correctly setting sheets in the paper feeding stage. The sheet set guidance may be displayed if the skew-related jam frequently occurs.

In the jam treatment, if the paper feed jam or the skew-related jam occurs, the life of the rollers of the paper feeding system in the paper feeding stage from which the jammed sheet is fed is checked and, if the life of the rollers runs out, the guidance for changing the paper feeding stage is displayed. Consequently, if a jam occurs in the paper feeding stage, in which the life of the rollers runs out, it is possible to urge the user to change the paper feeding stage.

In the jam treatment, if the paper feed jam or the skew-related jam frequently occurs, the guidance for changing the paper feeding stage may be displayed. Consequently, it is possible to urge the user to change the paper feeding stage in which the paper feed jam or the skew-related jam frequently occurs.

Processing for checking roller life and frequent occurrence of jams before starting printing is explained.

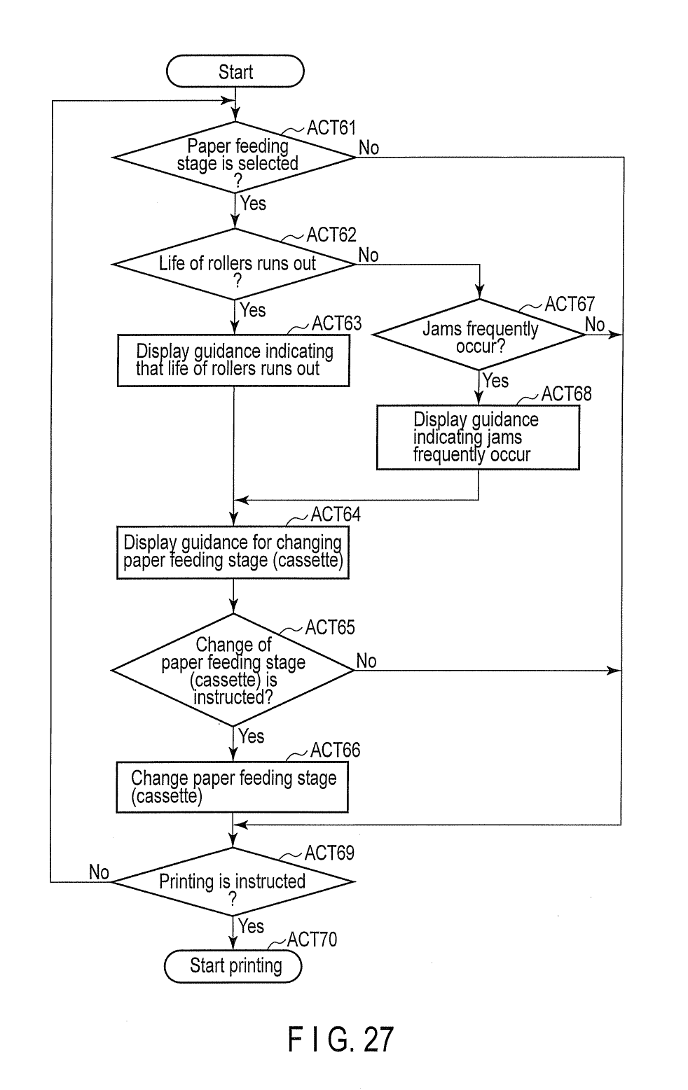

FIG. 27 is a flowchart for explaining a processing example for checking roller life and frequent occurrence of jams before starting printing.

The jam treatment shown in FIG. 14 includes processing for informing, if a jam occurs, the user of, for example, a change of the paper feeding stage if the life of the rollers runs out or jams frequently occur. On the other hand, the processing shown in FIG. 27 is processing for informing, before the start of printing (e.g., if the paper feeding stage is selected), the user of, for example, a change of the paper feeding stage if the life of the rollers runs out or jams frequently occur.

Specifically, if the user selects the paper feeding stage (the cassette 21 or the bypass feeder Bf) from which sheets are fed (YES in ACT 61), the main controller 50 checks the life of the rollers (the paper feeding mechanism) of the paper feeding system in the paper feeding stage (the cassette 21 or the bypass feeder Bf) selected by the user (ACT 62).

If the main controller 50 determines that the life of the rollers of the paper feeding system in the selected paper feeding stage runs out (YES in ACT 62), the main controller 50 displays on the display section 41 to the effect that the life of the rollers of the paper feeding system runs out (ACT 63). If the main controller 50 determines that the life of the rollers of the paper feeding system runs out (YES in ACT 62), the main controller 50 further displays, on the display section 41, the guidance for changing the paper feeding stage (the cassette 21 or the bypass feeder Bf) from which sheets are fed (ACT 64). For example, if there is another cassette 21 in which sheets same as the sheets stored in the currently-selected paper feeding stage are stored, the main controller 50 displays, on the display section 41, the guidance for urging the user to change the paper feeding stage to the other cassette 21 as in the display example shown in FIG. 23. If there is no other cassette 21 in which sheets same as the sheets stored in the currently-selected paper feeding stage are stored, the main controller 50 displays, on the display section 41, guidance for urging the user to change the paper feeding stage to the bypass feeder Bf as in the display example shown in FIG. 23.

If the change of the paper feeding stage is instructed (YES in ACT 65), the main controller 50 changes the setting of the paper feeding stage to the paper feeding stage to which the paper feeding stage is instructed to be changed (ACT 66). After changing the paper feeding stage, the main controller 50 waits for a printing instruction by the user and returns to ACT 61. If there is a printing instruction by the user in this state (YES in ACT 69), the main controller 50 starts printing (ACT 70). If the change of the paper feeding stage is not designated (NO in ACT 65), the main controller 50 returns to ACT 61 without the change of the paper feeding stage and starts printing according to a printing instruction by the user (ACT 70).

If the main controller 50 determines that the life of the rollers of the paper feeding system does not run out (NO in ACT 62), the main controller 50 determines whether jams frequently occur in the selected paper feeding stage (ACT 67). If the life of the rollers of the paper feeding system does not run out and jams do not frequently occur in the selected paper feeding stage (NO in ACT 67), the main controller 50 returns to ACT 61 and waits for a printing instruction by the user. If there is a printing instruction by the user in this state (YES in ACT 69), the main controller 50 starts printing (ACT 70).

If the main controller 50 determines that jams frequently occur in the selected paper feeding stage (YES in ACT 67), the main controller 50 displays guidance indicating that jams frequently occur in the selected paper feeding stage (ACT 68). If the main controller 50 determines that jams frequently occur in the selected paper feeding stage (YES in ACT 67), the main controller 50 further displays, on the display section 41, guidance for changing the paper feeding stage (the cassette 21 or the bypass feeder Bf) from which sheets are fed (ACT 67). For example, if there is another cassette 21 in which sheets same as the sheets stored in the currently-selected paper feeding stage are stored, the main controller 50 displays, on the display section 41, the guidance for urging the user to change the paper feeding stage to the other cassette 21 as in the display example shown in FIG. 25. If there is no other cassette 21 in which sheets same as the sheets stored in the currently-selected paper feeding stage are stored, the main controller 50 displays, on the display section 41, guidance for urging the user to change the paper feeding stage to the bypass feeder Bf as in the display example shown in FIG. 26.

If the change of the paper feeding stage is instructed (YES in ACT 65), the main controller 50 changes the setting of the paper feeding stage to the paper feeding stage to which the paper feeding stage is instructed to be changed (ACT 66). After changing the paper feeding stage or if the change of the paper feeding stage is not instructed (NO in ACT 65), the main controller 50 waits for a printing instruction by the user and returns to ACT 61. If there is a printing instruction by the user in this state (YES in ACT 69), the main controller 50 starts printing (ACT 70).

In the processing explained above, if the paper feeding stage is selected, the main controller 50 checks the life of the rollers of the paper feeding system in the selected paper feeding stage. If the life of the rollers runs out, the main controller 50 displays the guidance for changing the paper feeding stage. Consequently, it is possible to urge the user to change the paper feeding stage, in which the life of the rollers runs out, to another paper feeding stage before executing printing. If jams frequently occur in the selected paper feeding stage, the guidance for changing the paper feeding stage may also be displayed. Consequently, it is possible to urge the user to change the paper feeding stage, in which jams frequently occur, to another paper feeding stage before executing printing.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus comprising:
a paper feeding section configured to feed a set sheet;
a conveying section configured to convey the sheet fed from the paper feeding section;
an image forming section configured to form an image on the sheet conveyed by the conveying section; and
a display section configured to display sheet set guidance corresponding to a type of the sheet set in the paper feeding section.

2. The apparatus according to claim 1, wherein the display section displays the sheet set guidance if a paper feed jam due to the paper feeding section occurs.

3. The apparatus according to claim 2, wherein the display section displays the sheet set guidance if the paper feed jam due to the paper feeding section frequently occurs a number of times equal to or larger than a threshold.

4. The apparatus according to claim 2, wherein the display section displays, if the paper feed jam due to the paper feeding section occurs, jam release guidance for releasing the jam and displays sheet set guidance following the jam release guidance.

5. The apparatus according to claim 2, further comprising a skew determining section configured to determine, if a jam in the conveying section occurs, whether the jam is likely to be a skew-related jam due to a skew of the sheet fed from the paper feeding section, wherein
the display section displays the sheet set guidance if the skew determining section determines that the jam is the skew-related jam.

6. The apparatus according to claim 5, wherein the display section displays the sheet set guidance if the jam determined as the skew-related jam by the skew determining section frequently occurs a number of times equal to or larger than the threshold.

7. The apparatus according to claim 5, wherein the display section displays, if the jam determined as the skew-related jam by the skew determining section occurs, jam release guidance for releasing the jam and displays the sheet set guidance following the jam release guidance.

8. The apparatus according to claim 5, further comprising a skew detecting section configured to detect a skew of the sheet fed from the paper feeding section that occurs when the conveying section conveys the sheet, wherein
the skew determining section determines, according to a detection result by the skew detecting section, whether a skew is present in the sheet fed from the paper feeding section.

9. The apparatus according to claim 1, wherein
the paper feeding section is a cassette,
the paper feeding section includes an opening and closing sensor configured to detect opening and closing of the cassette functioning as the paper feeding section, and
the display section displays, if the opening and closing sensor detects that the cassette is opened, the sheet set guidance for setting a sheet in the cassette.

10. The apparatus according to claim 1, wherein
the paper feeing section is a bypass feeder,
the paper feeding section includes a sheet sensor configured to detect that a sheet is placed on the bypass feeder, and
the display section displays, if the sheet sensor detects that a sheet is placed on the bypass feeder, the sheet set guidance for setting a sheet in the bypass feeder.

11. A guidance display method used for an image forming apparatus, the method comprising:
determining whether sheet set guidance for setting a sheet in a paper feeding section is displayed;
specifying, if it is determined that the sheet set guidance is displayed, a type of the sheet stored by the paper feeding section; and
displaying the sheet set guidance corresponding to the type of the sheet set in the paper feeding section.

12. The method according to claim 11, wherein the determining includes determining, if a paper feed jam due to the paper feeding section occurs, that the sheet set guidance is displayed.

13. The method according to claim 12, wherein the determining includes determining, if the paper feed jam due to the paper feeding section frequently occurs a number of times equal to or larger than a threshold, that the sheet set guidance is displayed.

14. The method according to claim 12, further comprising:
displaying, if the paper feed jam due to the paper feeding section occurs, jam release guidance for releasing the jam; and
displaying the sheet set guidance following the jam release guidance.

15. The method according to claim 12, further comprising:
determining, if a jam in a conveying section occurs, whether the jam is likely to be a skew-related jam due to a skew of the sheet fed from the paper feeding section; and
displaying the sheet set guidance if it is determined in the determining that the jam is the skew-related jam.

16. The method according to claim 15, further comprising displaying the sheet set guidance if the jam determined as the skew-related jam frequently occurs a number of times equal to or larger than a threshold.

17. The method according to claim 15, further comprising:
displaying, if the skew related jam occurs, jam release guidance for releasing the jam; and
displaying the sheet set guidance following the jam release guidance.

18. The method according to claim 11, further comprising detecting opening and closing of a cassette functioning as the paper feeding section, wherein
the determining includes determining, if it is detected that the cassette is opened, whether the sheet set guidance for setting a sheet in the cassette is displayed.

19. The method according to claim 11, further comprising detecting that a sheet is placed on a bypass feeder functioning as the paper feeding section, wherein
the determining includes determining, if it is detected that a sheet is placed on the bypass feeder, whether the sheet set guidance for setting a sheet in the bypass feeder is displayed.

20. A guidance display method used for an image forming apparatus including plural paper feeding sections, the method comprising:
determining whether a life of a paper feeding mechanism in one paper feeding section selected as a paper feeding source of a sheet runs out;
displaying, if it is determined that the life of the paper feeding mechanism in the selected paper feeding section runs out, guidance for urging a change to another paper feeding section; and
changing setting of the paper feeding section according to an instruction for a change to another paper feeding section.
